(19) United States
(12) Patent Application Publication
(10) Pub. No.: US 2014/0342154 A1
(43) Pub. Date: Nov. 20, 2014

(54) PAPER PARTICULATE PELLET

(71) Applicant: FIBRECYCLE PTY LTD, Yatala (AU)

(72) Inventor: Donald B. Webb, Mt. Nathan (AU)

(73) Assignee: FIBRECYCLE PTY LTD, Yatala (AU)

(21) Appl. No.: 14/291,269

(22) Filed: May 30, 2014

Related U.S. Application Data
(63) Continuation of application No. PCT/AU2012/001461, filed on Nov. 30, 2012.

(30) Foreign Application Priority Data
Nov. 30, 2011 (AU) 2011904989

(51) Int. Cl. B29C 47/00; D02G 3/08; B29C 31/06

(52) U.S. Cl. CPC B29C 47/0059; B29C 47/0066; B29C 47/0011; B29C 31/065; D02G 3/08; B29K 2001/00
USPC 428/359; 264/141; 264/210.2; 428/402

(57) ABSTRACT

A pellet made from paper particulate extruded and cut into pellets, the pellet comprising an elongated form having opposite flattened surfaces separated by a pellet thickness. Also a process for producing paper particulate pellets comprising: extruding processed paper particulate into pellets having an elongated form; and flattening the extruded paper particulate such that the pellets have opposite flattened surfaces.

### BACKGROUND OF THE INVENTION

The present invention relates to a pellet made from paper particulate, such as a pellet used as animal bedding, and also relates to a process for producing paper particulate pellets.

Waste paper including old newspapers are a popular form of animal bedding. In some applications ‘animal bedding’ may also be referred to “animal litter”. Other forms of known animal bedding include silica gel in the form of granular crystals, wood chips, extruded paper pellets and granular clay particles.

Each form of animal bedding has associated advantages and disadvantages but a common disadvantage to extruded paper pellets is that they are prone to rolling and tend to escape confines when agitated by movement of an animal. Particularly for small animals, the particulate forms of animal bedding roll and slide from scurrying under foot which can cause the animal to slide and feel unstable and uncomfortable.

### SUMMARY OF THE INVENTION

In accordance with the present invention there is provided a pellet made from paper particulate extruded and cut into pellets, the pellet comprising an elongated form having opposite flattened surfaces separated by a pellet thickness.

In accordance with the present invention there is further provided a process for producing paper particulate pellets comprising:

extruding processed paper particulate into pellets having an elongated form; and

flattening the extruded paper particulate such that such that the pellets have opposite flattened surfaces.

The flattened pellets, as a result of their elongated and non-round cross-sectional shape tend to remain stationary and not roll under the animal. This is in contrast to traditional pellets that are cylindrical in shape and will easily roll with any movement of the animal.

In a preferred embodiment an average width of the flattened surfaces is greater than the thickness of the pellet. When viewed in cross-section along a width of the pellet, the pellet shape resembles a flattened oval, or a flattened ellipse. Top and bottom surfaces of the pellet are substantially flat and therefore stable on a flat surface.

In one embodiment, the pellets have a paper density of around 0.25 to 0.29 g/cm³.

The pellets may comprise a ridged, or crimped, surface that is caused by crimping the pellets between fluted rolls in a roller mill, which are also used to flatten the extruded pellets. The ridges, or crimps, on the surfaces run along the surface of the pellet and, in one embodiment, are inclined at an angle to an elongated direction, or axis, of the pellet; and namely the ridges are inclined relative to a longitudinal direction of the pellet.

Still further the ridges may run across the pellet. The angle of the ridges may lie diagonally to a longitudinal direction of the pellet and from anywhere between 0° and 90°, for example 45°. In practice, and as a result of the imprecise nature of the flattening process where pellets are presented for flattening at differing angles, it is expected the angle of the ridges relative to the longitudinal direction of the pellet will randomly vary from pellet to pellet.

The process for producing the pellets preferably includes using recycled paper and could even include within the process the recycling of paper material. This would include one or more of the steps of feeding paper through a grinder, grinding the paper to reduce it to a fibrous form, conditioning the fibrous paper by raising the moisture level of the paper, passing the conditioned fibrous paper through a density modification device, extruding the conditioned and modified paper and cutting the extrusion into pellets before flattening the pellets through a flattening station, such as a roll mill. Alternatively, the pellets may be extruded, flattened and then cut.

In a preferred embodiment, the step of flattening the pellets includes passing the pellets through counter rotating rollers that are separated by a gap that defines the thickness of the pellet, which in some embodiments will be less than a width of the flattened surfaces of the pellet as a result of the pellet being flattened and spread by the counter rotating rolls. The pellets are preferably dropped into the counter rotating rollers by controlled feeding under gravity.

In one embodiment the counter rotating rollers have fluted surfaces to provide traction to draw the pellet through the roll mill. The ridged surface caused by the fluted rollers additionally provides the pellet with a non-smooth and roughened surface that assists in preventing rolling and sliding of the pellet, while still maintaining a flatness to the opposite pellet surfaces.

In a preferred embodiment the flute peaks of one roller meet, or overlap, flute troughs of the other roller. In this case the pellet will have ridges on one flattened surface that are opposed by valleys on the other flattened surface.

The ridges, or flutes, on the surfaces of the counter rotating rollers may be set at an angle relative to the other roller which can provide the benefit of spreading of the nip point of the roller to uniformly spread the load of approaching pellets and ensure constant flow of pellets through the process.

In one aspect the method may also provide a volumetric discharger ahead of the flattening stage of the pellets to regulate the feed flow of the pellets to the flattening stage, and more specifically to the counter rotating rollers. The volumetric discharger may be a device that achieves consistent discharge of pellets to the flattening station by forcing the pellets by way of a rotating shaft into pockets formed on the shaft between partitions located along the length of the shaft.

### BRIEF DESCRIPTION OF THE DRAWINGS

Embodiments of the present invention will now be described by way of example with reference to the accompanying drawings, wherein:

FIG. 1 is an isometric view of a paper particulate pellet in accordance with an embodiment of the present invention;

FIG. 2 is a plan view of the pellet;

FIG. 3 is a side view of the pellet;

FIG. 4 is an end sectional view of the pellet taken at section A-A of FIG. 3;

FIG. 5a is a schematic representation of the process for producing paper particulate pellets in accordance with an embodiment of the present invention;

FIG. 5b is a partial side view of the schematic representation of FIG. 5b;

FIG. 6 is an isometric view of rollers used in flattening the pellets; and

FIG. 7 is a detailed side schematic view of the rollers flattening pellets.

### DETAILED DESCRIPTION

The drawings illustrate a pellet 10 produced from paper particulate, and preferably recycled paper particulate, where pellet 10 is suitable for use as animal bedding. While non-recycled paper could easily be used in the presently described process, it is considered to be more environmentally responsible to use recycled paper at no disadvantage to the final pellet product.

The pellet 10 is an extruded paper particulate pellet (which is a substantially cylindrical extrusion) that has been flattened and cut, or cut and flattened. Pellet 10 is small in size and in a longitudinal direction may have a maximum length of approximately 20 to 50 mm and on average is produced to have an average length of approximately 5 mm to 30 mm and more specifically 10 mm to 20 mm. However, because the pellet is of paper particulate, and is often of a recycled and biogradeable material, the pellet can break and may be shorter in length during use than the dimensions described above.

The pellet 10, unlike known cylindrically-shaped pellets, is flattened to produce two opposite and substantially flattened surfaces 12, and namely an upper flattened surface and a lower flattened surface. The flattened surfaces are flat relative to the cylindrically extruded shape of the pellet before flattening and relative to the remaining exposed edges of the pellet which include rounded sides 14 and end 16.

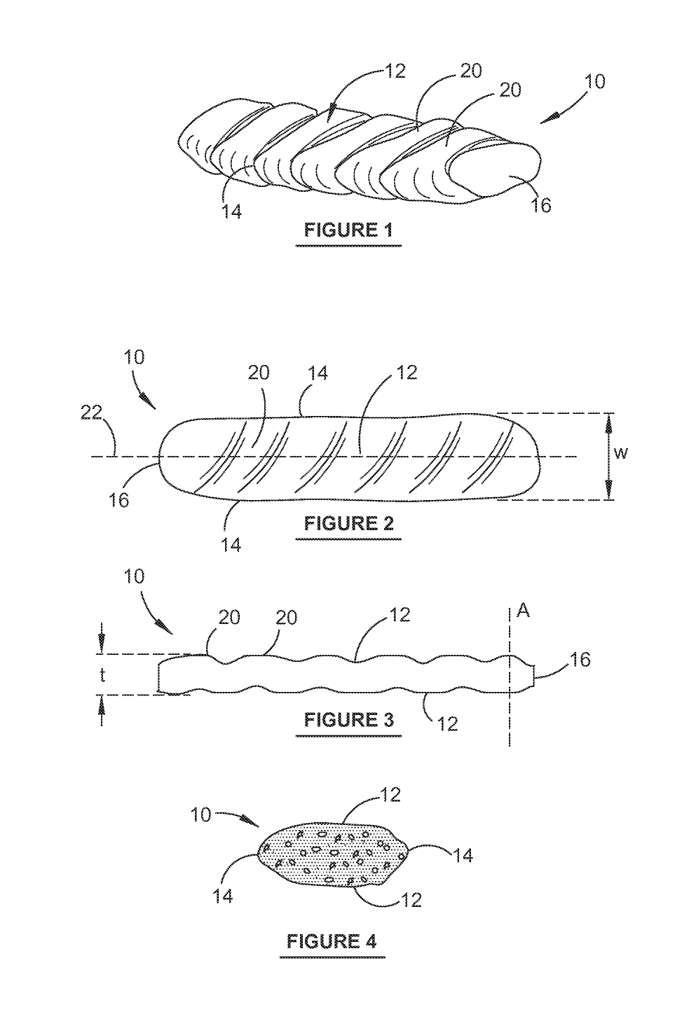

FIGS. 1 to 4 illustrate a singular pellet 10 from various views. Between the upper and lower flattened surfaces 12 the pellet has a thickness t where the average thickness is a value that is less than the average width w of the pellet as shown in FIG. 2. Accordingly, in cross section the pellet as illustrated in FIG. 4, taken at section A-A of FIG. 3, has a shape resembling a flattened oval.

It is understood by the term “flattened surface” the surface of the pellet 10 is not necessarily entirely flat, or smooth, but is substantially compressed or flattened to the point where one of the surfaces 12 of the pellet will, in a stable and rest condition, lie against a ground surface (that is level or inclined) without rolling and resist rolling when subjected to small movements. Accordingly, and as shown in FIGS. 1 to 4, flattened surfaces 12 may include undulations resulting in an uneven surface but which are on the whole substantially flat, particularly when compared to its pre-flattened state.

The flattened pellets used as animal bedding, which generally comprises hundreds and thousands of the pellets in one location, allow the pellets to retain their position and are less susceptible to rolling and sliding compared to un-flattened pellets. In use as animal bedding or as animal litter, the flattened pellets better hold their ground against animal movement or scurries and, depending on the force applied to the pellet, is more likely to stay confined and is less likely to roll or slide under an animal compared to un-flattened pellets. This provides the animal with more security and better ground coverage.

In the embodiment illustrated in the drawings, the pellet 10 also contains ridges 20 that may assist in providing traction against a ground surface to further reduce slipping and rolling and generally increase the friction of the flattened surfaces 12 of the pellet 10. Ridges 20 are a result of the manufacturing process described hereunder and may, as illustrated in FIGS. 1 to 4 be inclined relative to a longitudinal, elongated direction of the pellet 10, as indicated by longitudinal axis 22. FIG. 2, for example illustrates the ridges 20 being inclined to the longitudinal axis 22 at an angle of about 45°. However, depending on how the pellet enters the flattening station in the process, the ridges 20 may be produced at various angles and can lie anywhere between 0° to 90° to the longitudinal axis 22.

Also as a result of the flattening process, the ridges on one flattened surface may be out of phase with the ridges on the opposite surface, the degree of which will vary given the imprecise nature of the flattening process.

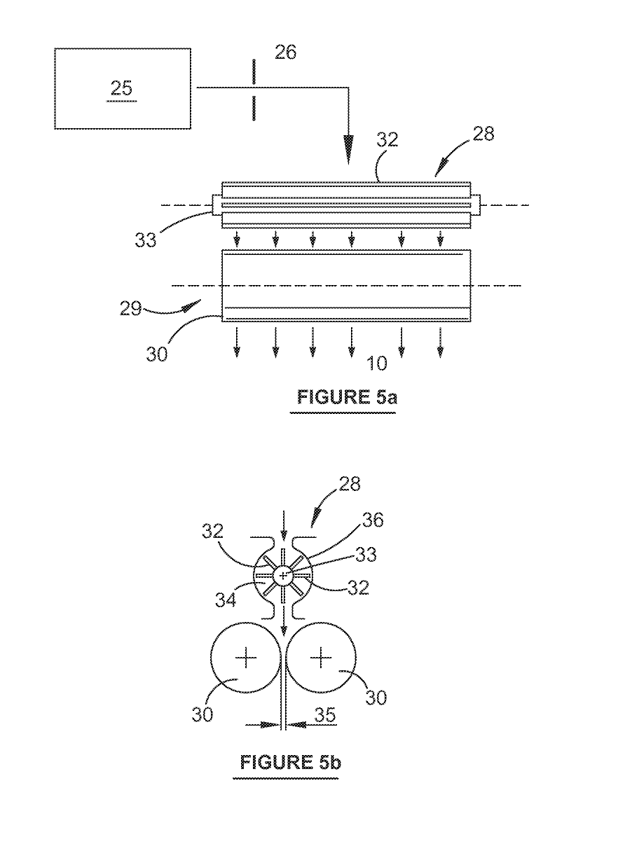

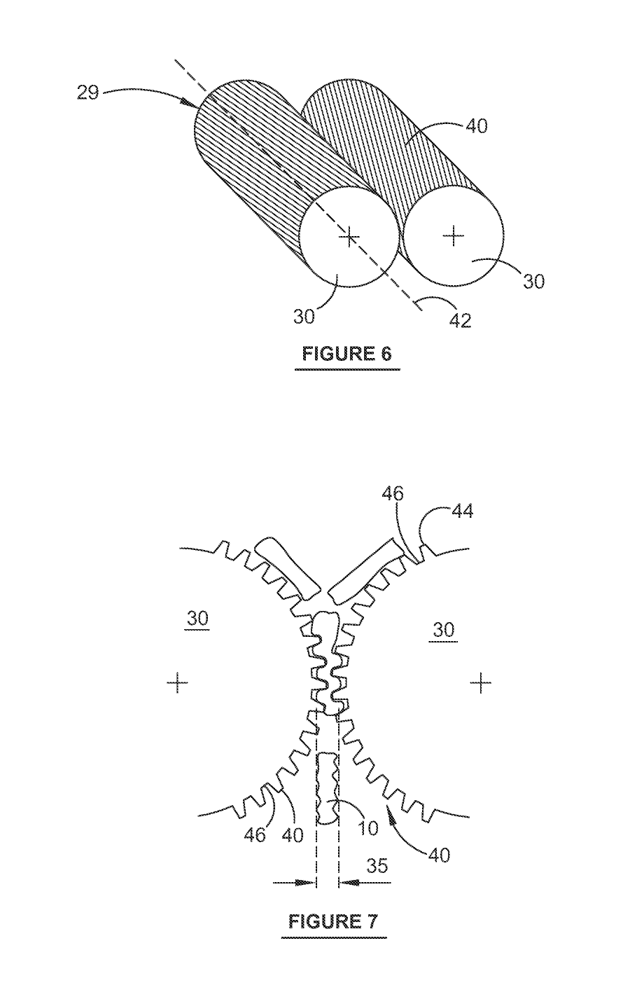

FIGS. 5a and 5b illustrate schematically the steps involved in the process for producing the paper particulate pellets 10. In fact, FIGS. 5a and 5b illustrates one portion of a larger paper to particulate recycling procedure, and the process in FIGS. 5a and 5b begins at extruder 25.

Before reaching extruder 25 paper material such as old newspaper for recycling, or any form of recyclable paper, is fed into a grinder where the paper is ground to produce a fibrous form having a fibre length that will bind the pellet in its extruded and pellet cut, flattened form. In its final flattened form the pellet has a density of about around 0.25 to 0.29 g/cm³.

Thereafter the fibrous paper is conditioned by raising the moisture level of the paper. The conditioned fibrous paper is then passed through a density modification device before reaching extruder 25. The density modification device adjusts the density of the conditioned fibre in the paper so as to enable a greater weight to be fed to the extrusion die for extruding the fibre into pellets.

None of the steps before reaching the extruder 25 are illustrated herein as it is understood that a skilled person could readily deduce the process leading to extruding fibrous paper product. It is also understood that the paper product may not necessarily begin with used paper for recycling but could begin with paper product pre-prepared especially for the purpose of producing the pellets described herein.

Once the conditioned fibrous paper reaches the extruder 25, the extruder extrudes fibrous paper into a long cylindrical stream whereby the extruded form is then cut to a desired length by cutter 26. At this point the cut extrusions form un-flattened pellets that are then conveyed to a volumetric discharger 28 that controls the distribution of un-flattened pellets to a flattening station 29, also referred to as a roller mill, containing a pair of counter rotating rollers 30. Rollers 30 flatten the pellets 10 by compressing the pellets through a gap 35 between the rollers 30.

In the process described herein the cutter 26 cuts the extruded paper form into pellets before entering the flattening station. It is however understood that the cutter 26 be positioned after the flattening station 29 in order to cut the extruded form into pellets after flattening the extruded form.

Volumetric discharger 28 regulates the feed flow of pellets by providing partitions 32 along a rotating shaft 33 in order to form segmented pockets 34 that deliver pellets to a flattening station, and namely the counter rotating rollers 30, by dropping the pellets onto the flattening station under gravity. The rotating discharger is encased in a tube 36 (see FIG. 5b) having guided openings along the length of the tube at an upper end and a lower end through which the un-flattened pellets respectively enter and exit the volumetric discharger.

The volumetric discharger achieves consistent discharge of pellets dispensed to the flattening station by forcing the pellets by way of the rotating shaft into the pockets formed by the partitions 32. The rate of dispensing is regulated by the speed of rotation of the discharger. The partitions may be thin, blade-like so as to not interfere with flow rate and whereby a greater number of partitions results in a greater number of, smaller, pockets that results in a greater even distribution of discharging pellets to the flattening station.

The flattening station 29 comprises a roll mill having a pair of metal counter rotating rollers as illustrated in FIG. 6 that rotate inwardly of each other to cause the pellets deposited on the rollers by the volumetric discharger 28 to feed into the gap 35 between the rollers 30 to flatten and squeeze the pellets 10 through the gap 35. Gap 35 has a width that is less than the diameter of an un-flattened pellet so that each pellet, regardless of the orientation at which it approaches the rollers 30, will be flattened as it passes through gap 35.

Corresponding to the ridges 20 of the pellet 10, rollers 30 are provided on their circumferential surface with fine flutes 40. Flutes 40 assist with traction of the pellets through gap 35 and encourage continued and constant feed of pellets through the flattening station. The flutes 40 may be provided at a diagonal to a longitudinal axis 42 of the rollers 30, as illustrated in FIG. 6, which can provide the benefit of spreading of the nip point of the roller to uniformly spread the load of approaching pellets and to ensure constant flow of pellets through the counter rotating rollers 30.

FIG. 7 illustrates the flutes 40 on the rollers 30 in closer detail. Raised peaks 44 of the flutes on one roller meet, over gap 35, recessed valleys 46 of the flutes on the other roller. This ensures the gap 35 between flutes on the opposite rollers remains substantially constant and does not choke or impinge the flow of pellets through the rollers. This overlapping of peaks to valleys also ensures the flattening force on the pellets is maintained to be substantially constant.

The thickness of the pellets 10 is determined by the spacing of the gap 35 and that gap can be adjusted depending on the size of the pellets to be produced and on the extent of the flattening desired. As a typical dimension the thickness of a flattened pellet can be about half the width of the pellet and as an example, that is intended to be by no way limiting, a pellet may have a thickness of 2-4 mm compared to a width of 4-8 mm. It is however understood that these dimensions may vary but the constant feature common to the pellets is that of flattening of a pellet to provide opposite flattened surfaces on which the pellet can sit and be less inclined to roll when acted on by a small force. Similarly the pellet will not roll on a slightly inclined ground surface under gravity.

The pellet described herein provides security and comfort to animals and assists in maintaining animal bedding within a confined area. By the absorbent nature of the paper particulate material used to make the pellet, the pellet also exhibits excellent absorbing properties suitable for use as animal bedding or so-called ‘kitty litter’.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. A pellet made from paper particulate ground to a fibrous form and extruded and cut into pellets, the pellet comprising an elongated form having opposite flattened surfaces separated by a pellet thickness, wherein an average width of the flattened surfaces is greater than the thickness of the pellet.

2. The pellet claimed in claim 1, wherein in cross-section the pellet is a flattened oval.

3. The pellet claimed in claim 1, wherein the pellet has a density of between 0.25 to 0.29 g/cm³.

4. The pellet claimed in claim 1, wherein the pellet has a length of between 5 mm to 50 mm.

5. The pellet claimed in claim 1, wherein the pellet is made of recycled paper particulate.

6. The pellet claimed in claim 1, comprising ridges on the flattened surfaces.

7. The pellet claimed in claim 6, wherein the ridges lie at an inclination to a direction of elongation of the pellet.

8. A process for producing paper particulate pellets comprising:
extruding processed paper particulate that has been ground to a fibrous form into pellets having an elongated form; and
flattening the extruded paper particulate such that the pellets have opposite flattened surfaces and an average width of the flattened surfaces is greater than the thickness of the pellet.

9. The process claimed in claim 8 comprising cutting the extruded paper particulate before or after flattening.

10. The process claimed in claim 8, comprising feeding paper particulate pellets into a flattening station under gravity.

11. The process claimed in claim 10, comprising regulating feed flow of paper particulate pellets into the flattening station using a volumetric discharger.

12. The process claimed in claim 8, comprising crimping the pellets to produce ridges on the opposite flattened surfaces.

13. The process claimed in claim 12, comprising inclining the ridges relative to a longitudinal direction of the pellet.
